(19) United States
(12) Patent Application Publication
(10) Pub. No.: US 2010/0089252 A1
(43) Pub. Date: Apr. 15, 2010

(54) Food Container with presser support disk fitted with retractable pressing pins

(76) Inventor: Kwang Suk Hong, Los Angeles, CA (US)

Correspondence Address: Eugene Oak, 610 South Van Ness Avenue, Los Angeles, CA, 90005, US

(21) Appl. No.: 12/288,131

(22) Filed: Oct. 15, 2008

(51) Int. Cl. B30B 1/00

(52) U.S. Cl. 99/495

(57) ABSTRACT

A food press and drainer for preparing fermented or pickled foodstuffs, where the apparatus is a cylindrical vessel and a closed bottom for containing food preparations, is presented in the present application. Solid foodstuffs which may or may not require the fluid to be extracted or separated during the preparation process; whereby, the extraction and separation is performed by a round support member hereinafter pressing disk, with pluralities of drain holes formed therein; where, the pressing disk has the shape of a circular disc with a head portion fitted to engage and retract pressing pins used to create sufficient friction between the pressing disk to the interior wall of the cylindrical vessel; wherein four mechanically retractable pressing pins exert pressure against the interior wall of the cylindrical vessel, thereby, securing the pressing disk within the cylindrical container, which, when said pins are in the engaged position the disk is thereby fixed in place at any chosen position; whereby, the pressing disk pressing pins are engaged within the cylindrical vessel; thereby, retaining solid foodstuff within the cylindrical vessel for the purpose of extracting and separating fluids from the solid foodstuffs in order to reuse the fluids for creating similar food preparations in multiple layers; or, so the container may be inverted, thereby permitting the fluid to drain from the container vessel while keeping the solids contained inside the cylindrical vessel after the vessel is inverted.

### BACKGROUND OF THE INTENTION

Some prepared foods must be contained in liquids for fermentation and for flavor conservation. For instance, Kimchi, a pickled foodstuff, must be prepared and preserved in its own juice; otherwise, the prepared pickle will lose its freshness and flavor. Often, foodstuff needs to be pressed during fermentation to obtain the best possible flavor.

Many fresh raw vegetables or food solids have a lower mass density than the fluid used in food preparation, therefore when the food solids are placed in a fluid, the vegetables will float, and only be partially submersed in the preparation fluid. Seasoning ingredients which often have a higher density then the preparation fluid sink to the bottom of the container. In order to ensure that the vegetables used in the food preparation have the proper seasoning, the food solids must remain submersed in the preparation fluid. Placing foods at the bottom of the container.

There is a need with respect to different food preparations where the fluid major may not need to be extracted or discarded to either preserve freshness, or reuse the preparation fluid.

### FIELD OF THE INVENTION

The current application relates to food containers with presser and fluid separator, with the function of preserving foodstuffs anaerobically.

### DESCRIPTION OF THE PRIOR ART

U.S. Pat. D512,881, to Bertulis, depicts a presser used to drain the preserving liquid from the food as the food is being pressed. The pressing is done by applying force to the pair of handles located at the topside of the can drainer's circumference.

U.S. Pat. D421,555, to Duhamel depicts a disc-shaped presser with pluralities of holes and a handling knob located at the center of the disc. Applying force to the handling knob does the pressing.

U.S. Pat. D105,367, to Swordling, depicts a partitioned draining bowl comprised of a container bowl and a draining bowl. This device is used to separate water from the food stored on the draining bowl.

U.S. Pat. No. 5,139,166, to Smith, presents a plate with drain inserts to remove water from foods. The plate can be inserted inside the food container. Water can then be separated by draining through the holes of the plate as the container is stored.

U.S. Pat. No. 5,706,721, to Homes, discloses a food can drainer comprised of a food can and a disc-shaped liquid drainer. The liquid is drained as the disc is pressed towards the bottom of the can.

U.S. Pat. No. 2,106,453, to Ekdahl, discloses a portable strainer with pluralities of grills and a handling tip outside the disc-shaped strainer for handling and setup. The liquid is drained as the strainer is set in place and the container is flipped. The liquid will drain through the grill but the food will remain inside the container.

U.S. Pat. No. 3,995,544, to Farley, discloses a device for time squeezer and strainer. The utensil is a device comprised of multiple draining holes with smaller than the circumference of the tuna can and a pair of support handles that can be doubled as feet when the device is inserted upside down. The liquid is drained by pressing the can towards the strainer.

U.S. Pat. No. 1,007,907, to Yaeger, discloses a meat or vegetable presser comprised of a container with a disc-shaped top, a bar with male screw tract, a secondary gear-shaped bar placed perpendicular to the screw bar and a turning handle done for pressing. The bottom of the container is comprised of pluralities of holes to permanently drain any liquids from the food.

None of the Prior Art disclose a device capable of pressing the food solids inside a contained fluid as part of the process for preparing the food. It is the object of the current application to correct such deficiencies.

### BRIEF DESCRIPTION OF THE DRAWINGS

FIG. 1 is a perspective view or the food container, demonstrating the compression disk's pressing pins in the retracted position, while the compression disk is submersed inside the walls of the food container.

FIG. 2 is a perspective view or the food container, demonstrating the compression disk's pressing pins in the engaged position, while the compression disk is submersed and affixed within the inside the walls of the food container.

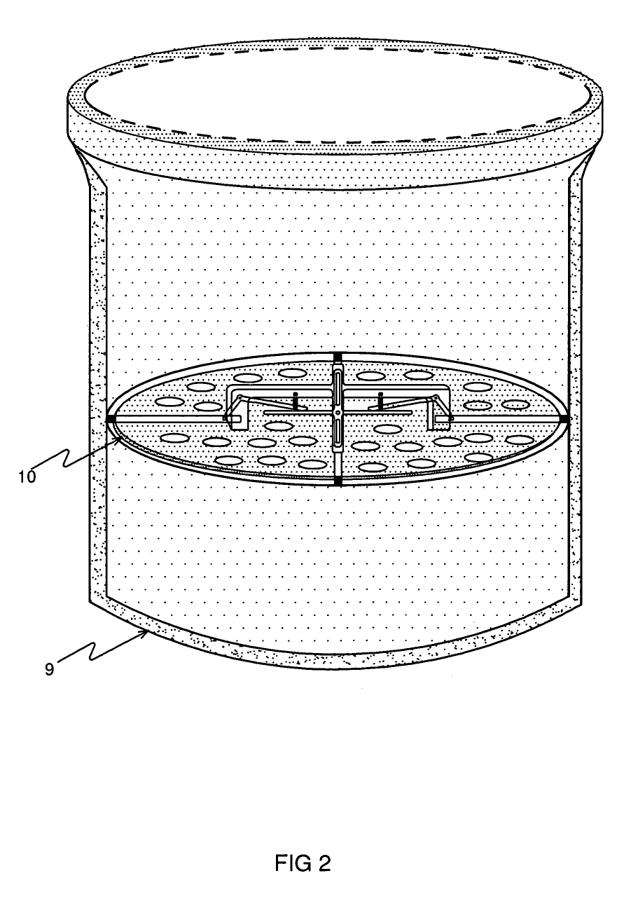

FIG. 3 is a perspective view, top, of the compression disk with the pressing pins apparatus affixed in the engaged position, demonstrating the mechanics of pressing pin apparatus.

FIG. 4 is a cross section view compression disk with the pressing pins apparatus affixed in the retracted position, demonstrating the mechanics of pressing pin apparatus in the disengaged position.

FIG. 5 is a cross section view compression disk with the pressing pins apparatus affixed in the engaged position, demonstrating the mechanics of pressing pin apparatus in the engaged position.

### DETAILED DESCRIPTION OF THE PREFERRED EMBODIMENTS

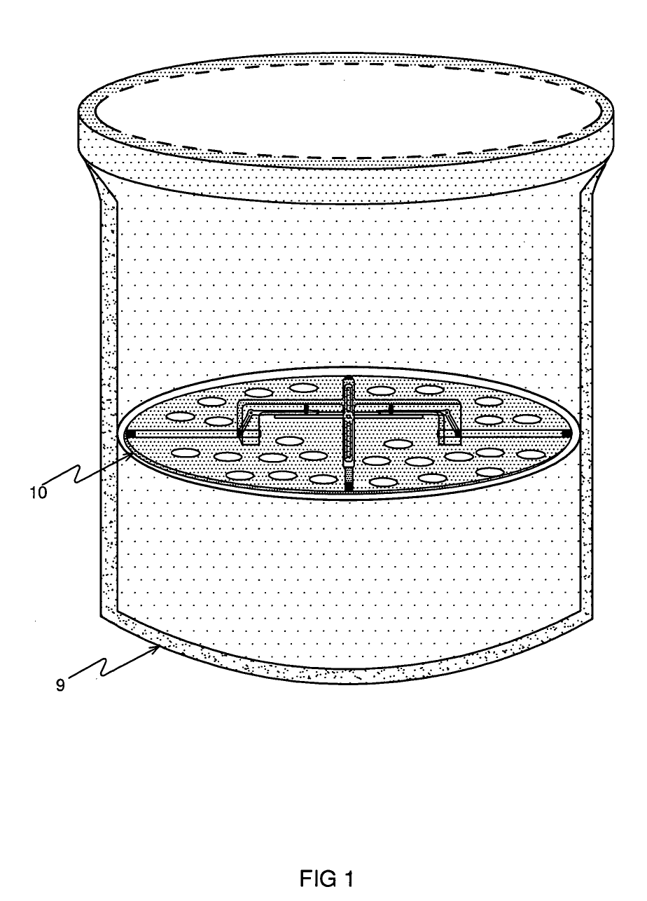

FIG. 1, is a perspective view of the cylindrical vessel, hereinafter referred to as the food container (9); comprised with a flat bottom for stability; and a round compression disc (10).

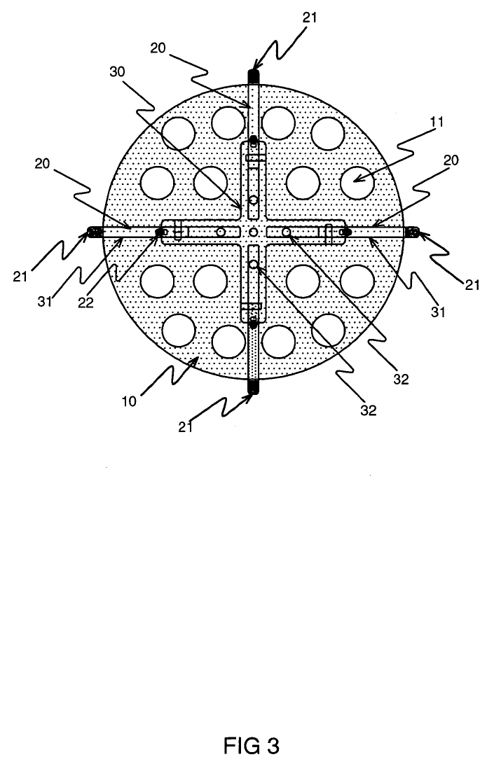

The compression disk (10) shown in FIG. 3, is comprised of a plurality of holes (11); four pressing pins (20); where each pressing pin as an affixed rubber pressing nub (21); wherein each pressing pin is fitted within the a corresponding pressing pin guide (31) thereby requiring four pressing pin guides, where the pressing pin guide (31) is cut within the compression disk (10) at 90 degree angles outward from the center of the compression disk; directly over the pressing pin guide (31) is a handle (30) which serves a handle for the user, and houses the mechanism for the mechanical operation of the pressing pins (20).

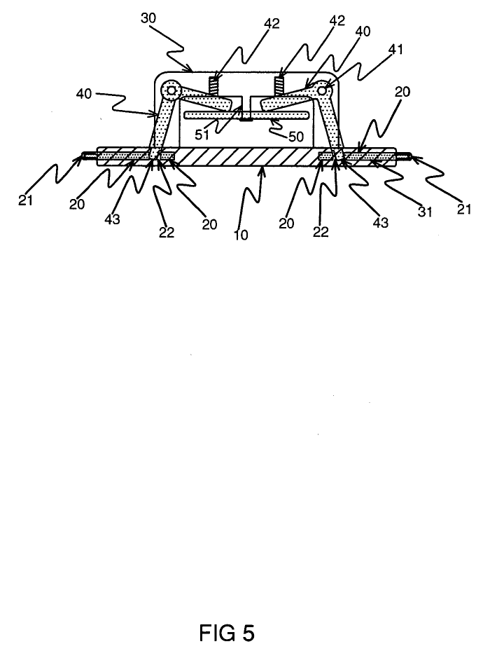

The compression disk pin mechanism shown in FIG. 5 is in the retracted position. The pressing pin mechanism shown in FIG. 5 is in the engaged position; where, each pressing pin (20) is has at the outer end a rubber pressing nub (21) and a pressing pin grove (22). Each pressing pin (20) is inserted within the a pressing pin guide (31) where the rubber pressing nub (21) is affixed on the outer edge of the compression disk (10) and the pressing pin groove (22) is positioned to mate with the corresponding leverage elbow nub (43). The leverage elbow nub (43) is affixed to the leverage elbow (40) where the angle of the leverage elbow (40) is 90 degrees where the leverage elbow (40) is set within the handle (30) and is affixed to the handle (30) by a leverage elbow pivot pin (41) set within the handle (30). The leverage elbow (40) actuates the movement of the individual pressing pins (20). The at rest position if the compression disk apparatus is in the engaged position. This is achieved by the use of four leverage elbow springs (42) placed between the handle (30) and the leverage elbow (40). Directly under the leverage elbows (40) is a gripping disk (50) which is a round disk with a hole in the center to accommodate a gripping disk center guide pin (51) whereby the gripping disk center guide pin (51) is affixed to the center of the handle (30) where the gripping disk (50) is mounted onto the gripping disk center guide pin (51) directly under the leverage elbows (40).

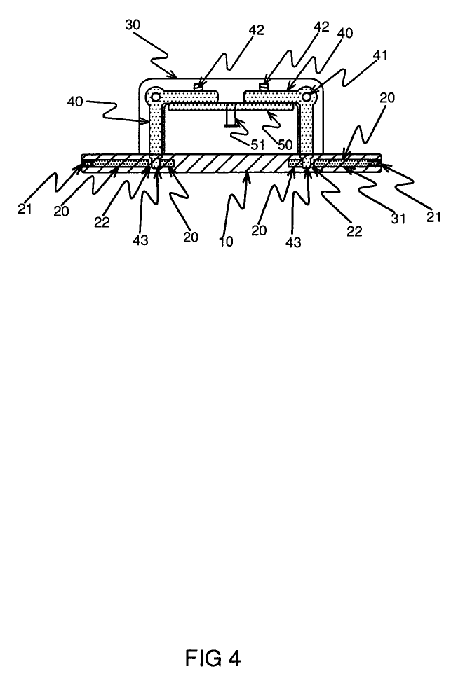

In FIG. 4 you see the mechanical movement of the gripping disk (50) upward by the end user, thereby pushing the leverage elbows (40) upward compressing the leverage elbow springs (41) where in the leverage elbow (40) pivots against the leverage elbow pivot pin (41) where the leverage elbow nub (43) inside the pressing pin groove (22) moves inward towards the center of the compression disk (10) thereby pulling the pressing pin (20) and the pressing pin nub (21) inwards towards the center of the compressing disk (10) the compression disk (10) pressing pins are thereby in the retracted position when the end user pulls upwards on the gripping disk (50).

As the compression disc (10) is placed by the user inside the food container (9) lower density food can be pressed the food towards the bottom of the food container (9) and liquid can be separated by flow through the plurality of holes (11) and the gap between the compression disc (9) and food container (9). As illustrated in FIG. 1, the circumference of the compression disc (10) is slightly smaller than the circumference food container (10). This allows for zero-force insertion of the compression disc (10) into the food container (9). The insertion of the compression disc (10) is essential to keep the lower density solid material at the bottom of the food container (9). The user will pull up on the gripping disk (50) thereby retracting via mechanical force, the pressing pins (20) and may insert the compression disk (10) inside the food container (9). At the desired location of the compression disk (10) within the food container (9) the user can release the pressure s/he exerts on the gripping disk (50) and the pressing pins (20) are thereby engaged. The rubber pressing nub (21) is thereby in contact with the outer wall of the food container (9) and is affixed in place.

Although the above description has been made in conjunction with the embodiment utilizing food container (9) with a compression disc (10) comprised of pluralities of holes (11) and the compression disk pin mechanism, it should be noted that the current application may be embodied by utilizing any container with the purpose of storing food with a compression disc (10). The pressing disc (10) may be comprised of a single hole (11) or the pressing disc (10) may comprised of grills (not illustrated) Furthermore, any other modifications and changes can be made by those skilled in the art, without departing from the spirit and scope of the current application.

What is claimed is:

1) A cylindrical shaft vessel whereas with an enclosed bottom on the lower annular end which opens upwards in an axial orientation;
and,
a corresponding disc with pluralities of holes; whereas, the disc is inserted in said cylindrical shaft where the major surface of said corresponding disc is transverse to the axial direction of the shaft vessel thereby pressing solid matter lower in density than the fluid, thus permitting fluid to pass through the holes of the disc preventing the solid matter from free floating in the fluid of said vessel wherein the corresponding disk has a mechanism utilizing pressing pins to affix the disk within the cylindrical vessel for the containment of solid foodstuff preparations with a fluid and separating said solid foodstuffs from the preparation fluid.

4) The cylindrical shaft vessel from claim 1; where the materials of construction is polypropylene.

5) The cylindrical shaft vessel from claim 1; where the materials of construction is wood.

6) The cylindrical shaft vessel from claim 1; where the materials of construction is clay.

7) The cylindrical shaft vessel from claim 1; where the materials of construction is glass.

8) The cylindrical shaft vessel from claim 1; where the materials of construction is stainless steel.
